(19) United States
(12) Patent Application Publication
(10) Pub. No.: US 2022/0127195 A1
(43) Pub. Date: Apr. 28, 2022

(54) USE OF AN ACIDIC SALT OF IRON (III) AS ADDITIVE FOR CEMENT, MORTAR OR CONCRETE

(71) Applicant: HOLCIM TECHNOLOGY LTD, ZUG (CH)

(72) Inventors: Olivier WATT, HOLDERBANK (CH); Delphine THOMAS, HOLDERBANK (CH)

(21) Appl. No.: 17/430,153

(22) PCT Filed: Feb. 13, 2020
(86) PCT No.: PCT/EP2020/053814

§ 371 Date: Aug. 11, 2021

(30) Foreign Application Priority Data
Feb. 15, 2019 (EP) 19305190.1

(51) Int. Cl. C04B 22/14; C04B 24/12; C04B 28/04; C04B 22/06; C04B 103/50

(52) U.S. Cl. CPC C04B 22/149; C04B 24/122; C04B 2103/50; C04B 22/064; C04B 28/04

(57) ABSTRACT

A method includes adding an acidic salt of Iron (III) as additive to cement, mortar or concrete.

### FIELD OF THE INVENTION

The invention relates to additives for cement, mortar or concrete, in particular the use of an acidic salt of Iron (III) as additive for cement, mortar or concrete as well as a cement hydraulic binder comprising such an additive and a method for improving early compressive strength of hydraulic cement composition by adding such an additive.

### BACKGROUND OF THE INVENTION

Various additives are used in the field of hydraulic cement compositions in order to modify the rheology of the cement composition or the mechanical properties of the resulting material.

Notably, diverse additives increasing compressive strength of cement, mortar or concrete have been designed. In particular, alkanolamines such as monoethanolamine, diethanolamine or triethanolamine have been used as set accelerators. They are known to improve early compressive strength.

Other tertiary amine have also been identified as enhancing compressive strength of cements at 7 days and at 28 days as illustrated by EP 0415799.

In the present invention, it was discovered that acidic salts of iron (III) can be used as additives for cement, mortar or concrete. They lead to improved compressive strength of the resulting cement, mortar or concrete. More particularly, it was observed that early compressive strength is enhanced, preferably compressive strength at 1 day, or compressive strength at 1 day and 7 days.

### SUMMARY OF THE INVENTION

The present invention relates to the use of an acidic salt of Iron (III) as additive for cement, mortar or concrete.

Preferably, the acidic salt of Iron (III) is selected from the group comprising iron(III) sulfate, iron (III) chloride, iron (III) nitrate, iron (III) carboxylate and combinations thereof. In particular, an alkanolamine is used in combination with the acidic salt of Iron(III).

The invention also relates to a composition of additives for cement, mortar or concrete, comprising an acidic salt of Iron (III), advantageously selected from the group comprising iron(III) sulfate, iron (III) chloride, iron (III) nitrate, iron (III) carboxylate and combinations thereof, and an alkanolamine, advantageously selected from the group comprising N,N bis-(2-hydroxyethyl)-2-propanolamine) (DIEPA), N, N bis-(2-hydroxypropyl)-N-(hydroxyethyl) amine (EDIPA), diethanolamine (DEA), triethanolamine (TEA), triisopropanolamine (TIPA), hydroxyethyldiethylenetriamine (HEDETA), and aminoethylethanolamine (AEEA) and combinations thereof, more advantageously selected from N,N bis-(2-hydroxyethyl)-2-propanolamine) (DIEPA), N, N bis-(2-hydroxypropyl)-N-(hydroxyethyl) amine (EDIPA), triisopropanolamine (TIPA), hydroxyethyldiethylenetriamine (HEDETA) and combinations thereof.

Preferably, the composition of additives further comprises a source of calcium oxide and/or an antifoaming agent.

The invention relates to a method for improving compressive strength of hydraulic cement composition comprising a Portland cement, wherein an acidic salt of Iron (III), advantageously selected from the group comprising iron(III) sulfate, iron (III) chloride, iron (III) nitrate, iron (III) carboxylate and combinations thereof, is added to the hydraulic cement composition.

In particular, an alkanolamine is further added to the hydraulic cement composition in the method according to the invention. Advantageously, the alkanolamine is selected from the group comprising N, N bis-(2-hydroxyethyl)-2-propanolamine) (DIEPA), N, N bis-(2-hydroxypropyl)-N-(hydroxyethyl) amine (EDIPA), diethanolamine (DEA), triethanolamine (TEA), triisopropanolamine (TIPA), hydroxyethyldiethylenetriamine (HEDETA), and aminoethylethanolamine (AEEA) and combinations thereof, advantageously is selected from N,N bis-(2-hydroxyethyl)-2-propanolamine) (DIEPA), N, N bis-(2-hydroxypropyl)-N-(hydroxyethyl) amine (EDIPA), triisopropanolamine (TIPA), hydroxyethyldiethylenetriamine (HEDETA) and combinations thereof.

Preferably, a source of calcium oxide and/oran antifoaming agent is further added to the hydraulic cement composition in the method according to the invention.

In particular, at least 0.1% by weight, advantageously from 0.4 to 4% by weight, compared to the total weight of binder, of salt of Iron (III) is added in the method according to the invention.

Preferably, at least 0.02% by weight, advantageously from 0.05 to 0.2% by weight, compared to the total weight of binder, of alkanolamine is added in the method according to the invention.

The invention also relates to a cement hydraulic binder comprising Portland cement and at least one acidic salt of Iron (III), in particular in an amount of at least 0.1% by weight of Iron (Fe) compared to the total weight of binder.

In particular, the cement hydraulic further comprises an alkanolamine, advantageously in a content of at least 0.05% by weight compared to the total weight of binder. Preferably, the cement hydraulic binder comprises at least 0.8% by weight, preferably at least 1.3% by weight, compared to the total weight of binder, of free calcium oxide. Advantageously, the cement hydraulic binder further comprises an antifoaming agent, more advantageously in a content of at least 0.05% by weight compared to the total weight of binder.

The invention relates to a hydraulic cement composition comprising the cement hydraulic binder according to the invention.

Finally, the invention relates to a structure formed from the hydraulic cement composition according to the invention.

### DETAILED DESCRIPTION OF EMBODIMENTS OF THE INVENTION

Definition of cement, binder, mortar and concrete A cement is a hydraulic binder comprising a proportion of at least 50% by weight of calcium oxide (CaO) and silicon dioxide (SiO₂). Cement sets and slowly hardens when mixed with water. The binder may contain other components in addition to CaO and SiO₂, in particular slag, silica fume, pozzolans (natural and calcined), fly ash (siliceous and calcic) and/or limestone.

A cement mixed with fine aggregate (sand) and water produces mortar.

A cement mixed with fine and coarse aggregate (sand and gravel) and water produces concrete.

In particular, the binder in the present invention is a Portland cement. Portland cement is a mixture of ground Portland clinker, a source of calcium sulfate such as gypsum or anhydrite, optionally mineral components and minor additions, as described in the cement standard NF EN 197-1 published in April 2012.

Preferably, ground Portland clinker has the following mineralogical composition, % in weight compared to the total weight of the clinker:
50 to 80 wt. % of C3S (alite),
4 to 40 wt. % of C2S (belite),
0 to 20% wt. of C4AF (ferrite or aluminoferrite or brownmillerite),
0 to 15% wt. of C3A (aluminate),

and secondary mineral components.

In particular, the sum of the amount of C4AF and C3A phases in the ground Portland clinker is higher than 0% wt. compared to the total weight of clinker. More preferably, the amount of C4AF phase and/or the amount of C3A phase in the ground Portland clinker is higher than 0% wt. compared to the total weight of clinker.

The mineralogical components of Portland clinker are noted according to the common cement industry notation:
C represents CaO,
A represents Al₂O₃,
F represents Fe₂O₃, and
S represents SiO₂.

Preferentially, the cement suitable in the present invention is a CEM 1, as described in the cement standard NF EN 197-1 published in April 2012.

Portland cement CEM I comprises at least 95 wt. % of a ground Portland clinker compared to the total weight of cement.

The other cement types described in the cement standard NF EN 197-1 published in April 2012 (CEM II, CEM II, CEM IV, CEM V) may also be used. The cement may be then a mixture of a CEM I and mineral additions.

Thus, the binder may also be a mixture of Portland cement as described in the European standard NF EN 197-1 Standard of April 2012 with other mineral components.

Preferably, the binder may comprise 0 to 50 wt. % of mineral components, more preferably from 0 to 40 wt. %, most preferably from 0 to 30 wt. %, the percentages being expressed by mass relative to the mass of cement.

The mineral components used according to the invention may be slags (for example, as defined in the European NF EN 197-1 Standard of April 2012, paragraph 5.2.2), pozzolanic materials (for example as defined in the European NF EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), silica fume (for example, as defined in the European NF EN 197-1 Standard of April 2012, paragraph 5.2.7), siliceous additions (for example, as defined in the “Concrete” NF P 18-509 Standard), metakaolin or mixtures thereof.

A fly ash is generally a powdery particle comprised in the fumes from coal-fired thermal power stations. It is generally recovered by electrostatic or mechanical precipitation. The chemical composition of a fly ash mainly depends on the chemical composition of the coal burned and of the method used in the power plant from which it comes. The same is true for its mineralogical composition. The fly ashes used according to the invention may be of siliceous or calcic nature.

Slags are generally obtained by rapid cooling of the molten slag coming from the melting of iron ore in a blast furnace. Slags may be selected from granulated blast furnace slags according to the European standard NF EN 197-1 of February 2001 paragraph 5.2.2.

Silica fumes may be a material obtained by reduction of high purity quartz by carbon in electric arc furnaces used for the production of silica and ferrosilica alloys. Silica fumes are generally formed of spherical particles comprising at least 85% by weight of amorphous silica. Preferably, the silica fumes are selected from silica fumes according to the European standard NF EN 197-1 of April 2012 paragraph 5.2.7.

Pozzolanic materials may be natural siliceous or silico-aluminous substances, or a combination thereof. Among pozzolanic materials may be cited natural pozzolans, which are in general materials of volcanic origin or sedimentary rocks, and natural calcinated pozzolans, which are materials of volcanic origin, clays, schists or sedimentary rocks, thermally active.

Preferably, the pozzolanic materials may be selected from pozzolanic materials according to the European standard NF EN 197-1 of April 2012 paragraph 5.2.3.

Use

The invention relates to the use of an acidic salt of Iron (III) as additive for cement, mortar or concrete.

Acidic salts of Iron (III), also known as acidic ferric salts, are salts comprising as a cation Iron in the +3 oxidation state and as an anion a salt of Bronsted acid with a pKa strictly below 7. They can notably be obtained by reaction of iron ore on mineral acids or reaction of Iron salt (II) and an oxidant.

It was surprisingly found that acidic salts of Iron(II) can be used as additive for cement, mortar or concrete. They can improve compressive strength, in particular early compressive strength, notably at 1 day or even at 1 day and at 7 days.

In particular, the salt of Iron (III) is an acidic mineral salt of Iron (III).

Preferably, the acidic salt of Iron (III) is selected from the group comprising iron(III) sulfate, iron (III) chloride, iron (III) nitrate, iron(III) carboxylate and combinations thereof. More preferably the acidic salt of Iron (III) is Iron(III) sulfate, in particular Iron(III) sulfate monohydrate (Fe₂(SO₄)₃.H₂O).

In particular the acidic salt of Iron (III) is Iron(III) carboxylate, more particularly iron (III) citrate.

It was also surprisingly found that the combination of an acidic salt of Iron (III) with an alkanolamine can be used as additive for cement, mortar or concrete. A synergistic effect with the combination is observed as the compressive strength is further improved, in particular the early compressive strength, preferably the compressive strength at 1 day, or the compressive strength at 1 day and 7 days.

Preferably, alkanolamine is selected from the group comprising N,N bis-(2-hydroxyethyl)-2-propanolamine) (DIEPA), N, N bis-(2-hydroxypropyl)-N-(hydroxyethyl) amine (EDIPA), diethanolamine (DEA), triethanolamine (TEA), triisopropanolamine (TIPA), N-(hydroxyethyl)diethylenetriamine (HEDETA), and aminoethylethanolamine (AEEA) and combinations thereof.

Advantageously, the alkanolamine is a tri(hydroxyalkyl)amine, more particularly, a tri(hydroxyalkyl)amine having at least one C3-C5 hydroxyalkyl group, or a combination thereof.

Advantageously, the C3-C5 hydroxyalkyl group is a C3 hydroxyalkyl group, preferably is a hydroxypropyl group.

Advantageously, the tri(hydroxyalkyl)amine comprises 1, 2 or 3 C3-C5 hydroxyalkyl group(s), the remaining hydroxyalkyl group(s) advantageously being C2 hydroxyalkyl group(s). The alkanolamine is advantageously selected from N bis-(2-hydroxypropyl)-N-(hydroxyethyl) amine (EDIPA), N,N bis-(2-hydroxyethyl)-2-propanolamine) (DIEPA) and triisopropanolamine (TIPA), and combinations thereof or more advantageously selected from N,N bis-(2-hydroxyethyl)-2-propanolamine) (DIEPA), triisopropanolamine (TIPA) and combinations thereof.

In particular, alkanolamine is N,N bis-(2-hydroxyethyl)-2-propanolamine) (DIEPA).

In particular, alkanolamine is triisopropanolamine (TIPA).

In particular, the acidic salt of Iron (III), optionally in combination with an alkanolamine, advantageously a tri(hydroxyalkyl)amine as described hereinabove, more advantageously a tri(hydroxyalkyl)amine having at least one C3-C5 hydroxyalkyl group, is used as additive for improving compressive strength of the cement, mortar or concrete. Preferably, compressive strength at 1 day is improved, more preferably compressive strength at 1 day and 7 days, even more preferably compressive strength at 1 day, at 7 days and at 28 days.

The acidic salt of Iron(III) can further be combined with a source of calcium oxide. The source of calcium oxide can be quicklime or burnt lime.

It is assumed that due to its acidity, the salt of Iron (III) might supposedly react with limestone present in the cement (free lime). This might lead to undesirable carbon dioxide emission. A source of calcium oxide might react instead with the acidic salt of iron (III) and thus limit the side reaction and emission of carbon dioxide.

The acidic salt of Iron(III) can further be combined with an antifoaming agent. Antifoaming agent can for example be a polydimethylsiloxane or it can comprise silicones as a solution, solid or preferably as a resin, oil or an emulsion, preferably in water. Silicones comprising groups (RSiO_{0.5}) and (R₂SiO) are most particularly suitable. In these formulae, the radicals R, which may either be identical or different, are preferably a hydrogen atom or an alkyl group with 1 to 8 carbon atoms, the methyl group being preferred. The number of units is preferably from 30 to 120.

Indeed, it is possible that of small amounts of carbon dioxide production might occur as the acidic salt of Iron (III) might supposedly react with limestone present in the cement. In order to limit foaming and gaz bubbles entrapped in the cement, it would be advantageous to combine the acidic salt of Iron (III) with an antifoaming agent.

Thus, the acidic salt of Iron (1111) can be used in combination with other additives such as an alkanolamine, a source of calcium oxide and/or an antifoaming agent.

The additives can be added to the cement, mortar or concrete simultaneously or separately, at different steps of the manufacture of the cement, mortar or concrete.

When a source of calcium oxide is also added to the cement, mortar or concrete, because calcium oxide is not already present in the binder in a sufficient amount to neutralize the salt of Iron(III), addition of the source of calcium oxide occurs prior to addition of salt of Iron(III).

Each additive can be used in cement, mortar or concrete by mixing it in the clinker, prior or after its grinding. It can also be mixed in the binder, in the mixing water or in the aggregates if present.

It can be mixed before or following the mixing of the binder with water and optionally the aggregates.

One skilled in the art would add each additive appropriately to the cement, mortar or concrete. In particular, solid additives can be mixed with the binder whilst liquid additives can be added in the mixing water.

Composition of Additives:

In a specific embodiment, part or all of the additives are mixed together prior to addition in the cement, mortar or concrete.

Thus, the invention also relates to a composition of additives for cement, mortar or concrete, comprising an acidic salt of Iron (III) and an alkanolamine.

Salt of Iron (III) and alkanolamine are as described above.

Preferably, the composition of additives further comprises a source of calcium oxide as described above.

Preferably, the composition of additives further comprises an antifoaming agent as described above.

Method

The invention also relates to a method for improving compressive strength of hydraulic cement composition comprising a Portland cement, wherein an acidic salt of Iron (III) is added to the hydraulic cement composition.

Indeed, as described above, it was found that addition of an acidic salt of Iron (III) to a hydraulic cement composition allows improving its compressive strength.

In particular, compressive strength at 1 day of hydraulic cement composition is improved by the method according to the invention, preferably compressive strength at 1 day and at 7 days, even more preferably compressive strength at 1 day, at 7 days and at 28 days. The hydraulic cement composition comprises a binder and water, and optionally fine and/or coarse aggregate.

The binder is as described above.

The salt of Iron (III) is as described above.

Advantageously, in the method according to the invention, at least 0.1% by weight, more advantageously from 0.4 to 4% by weight, compared to the total weight of binder, of acidic salt of Iron (III) is added.

As described above, it was found that adding an acidic salt of Iron (III) and an alkanolamine to a hydraulic cement composition leads to a synergistic effect and further improves the compressive strength of the hydraulic cement composition.

Accordingly, in particular, the method according to the invention comprises a step of addition of at least one alkanolamine to the hydraulic composition.

The alkanolamine is as described above and advantageously is a tri(hydroxyalkyl)amine, more advantageously a tri(hydroxyalkyl)amine having at least one C3-C5 hydroxyalkyl group or a combination thereof.

Advantageously, at least 0.02% by weight, more advantageously from 0.05 to 0.2% by weight, compared to the total weight of binder, of alkanolamine is added.

The presence of calcium oxide in the hydraulic cement composition might be advantageous in order to limit a potential emission of carbon dioxide.

Calcium oxide can already be present in the binder as free lime.

The method according to the invention can also comprises a step of addition of a source of calcium oxide as described above in the hydraulic composition.

Advantageously, at least 0.5% by weight, more advantageously from 0.8 to 2% by weight, compared to the total weight of binder, of a source of calcium oxide is added.

It can be advantageous to add an antifoaming agent to the hydraulic composition in order to limit a potential formation of foam through emission of carbon dioxide. This is in particular the case when calcium oxide is not present in the binder in a sufficient amount to neutralize the salt of Iron(III). Calcium oxide can be free lime present in the binder and/or an added source of calcium oxide.

Accordingly, the method according to the invention comprises a step of addition of an antifoaming agent as described above in the hydraulic composition.

Advantageously, at least 0.02% by weight, more advantageously from 0.05 to 0.1% by weight, compared to the total weight of binder, of an antifoaming agent is added.

Each additive, including the acidic salt of Iron (III), the alkanolamine, the source of calcium oxide and the antifoaming agent, can be added in a separate step or simultaneously.

Each additive can be added to the clinker, prior or after its grinding, to the binder, to the mixing water or to the aggregates if appropriate.

Each additive can also be added to the mix of the binder, the mixing water and the aggregates if appropriate.

When a source of calcium oxide is also added to the cement, mortar or concrete, because calcium oxide is not already present in the binder in a sufficient amount to neutralize the salt of Iron(III), addition of the source of calcium oxide occurs prior to addition of salt of Iron(III).

One skilled in the art would add each additive at the appropriate step. In particular, the following two embodiments can be envisioned.

In a first embodiment, the method according to the invention comprises a step of mixing at least one acidic salt of Iron (III), with the hydraulic cement binder comprising Portland cement, in particular before addition of water.

In particular, in said step of mixing, the alkanolamine, the source of calcium oxide and/or the antifoaming agent are also mixed to the acidic salt of Iron (III) and the hydraulic cement binder.

Notably, an acidic salt of Iron (III) is added to the clinker prior to grinding. After grinding, a ground clinker comprising an acidic salt of Iron (III) is obtained.

Then, the ground clinker comprising an acidic salt of Iron (III) can be mixed with the other components of the binder.

In another embodiment, the binder is obtained by mixing a ground clinker, an acidic salt of Iron (III) and optionally other components of the binder.

In a second embodiment, the method according to the invention comprises a step of mixing the cement hydraulic binder comprising Portland cement with water, aggregates and at least one acidic salt of Iron (III).

In particular, in said step of mixing, the alkanolamine, the source of calcium oxide and/or the antifoaming agent are also mixed to the acidic salt of Iron (III), the cement hydraulic binder, water and aggregates.

Notably, in this embodiment, the acidic salt of Iron (III) can be mixed with the mixing water. The mixing water comprising a salt of Iron (III) is then mixed with the binder and the aggregate if applicable.

In addition, the method according to the invention can also comprise a step of addition of other additives such as plasticizers, superplasticizers, thickening agents, viscosifying agents, air entraining agents, setting retarders, setting accelerators, coloured pigments, hollow glass beads, film forming agents, hydrophobic agents or de-polluting agents (for example zeolites or titanium dioxide), latex, organic or mineral fibres, or their mixtures.

Cement Hydraulic Binder

The invention also relates to a cement hydraulic binder comprising Portland cement and at least one acidic salt of Iron (III) and advantageously an alkanolamine as described above, advantageously a tri(hydroxyalkyl)amine, more advantageously a tri(hydroxyalkyl)amine having at least one C3-C5 hydroxyalkyl group or a combination thereof.

The cement hydraulic binder according to the invention allows obtaining cement, mortar or concrete with improved compressive strength, in particular at 1 day, more particularly at 1 day and 7 days, even more particularly at 1 day, at 7 days and at 28 days.

In particular, the cement hydraulic binder according to the invention comprises at least 0.1% by weight of Iron (Fe) compared to the total weight of binder.

Preferably, the cement hydraulic binder according to the invention further comprises an alkanolamine as described above, advantageously in a content of at least 0.05% by weight compared to the total weight of binder.

In particular, the cement hydraulic binder according to the invention comprising at least 0.8% by weight, preferably at least 1.3% by weight, compared to the total weight of binder, of free calcium oxide.

Calcium oxide that survives processing without reacting in building products such as cement is called free lime. Free lime can be present in Portland cement. If the amount of free lime from the Portland cement in the binder is below the required amount necessary (i.e. 0.8% by weight or 1.3% by weight, compared to the total weight of binder), a source of calcium oxide as described above can also be added to the cement hydraulic binder to reach the required amount of free lime.

Advantageously, the cement hydraulic binder according to the invention further comprises an antifoaming agent, notably as described above, more advantageously in a content of at least 0.05% by weight compared to the total weight of binder.

In particular, the cement hydraulic binder according to the invention can further comprise other additives such as plasticizers, superplasticizers, thickening agents, viscosifying agents, air entraining agents, setting retarders, setting accelerators, coloured pigments, hollow glass beads, film forming agents, hydrophobic agents or de-polluting agents (for example zeolites or titanium dioxide), latex, organic or mineral fibres, or their mixtures. These other additives may be added to the cement during its manufacturing, or during the preparation of concrete.

Hydraulic Cement Composition

The invention also relates to a hydraulic cement composition comprising the cement hydraulic binder according to the invention.

The hydraulic cement composition according to the invention can comprise aggregates. In particular, it can comprise fine aggregates or a mix of fine and coarse aggregates.

Aggregates can be aggregates of silica or limestone or a mixture of different types of aggregates. They may also come from former recycled concrete. They may be rounded or crushed aggregates.

The invention also relates to a structure formed from the hydraulic cement composition according to the invention.

### Examples

Materials

4 binders have been used in the following examples:

TABLE 1

| | | Le Teil | | VDZ | Le Teil |
|---|---|---|---|---|---|
| | | Blanc | Singapore | PMES | PMES |
| | SiO₂ | 23.2 | 19.9 | 20.7 | 22.4 |
| | Al₂O₃ | 2.5 | 5.6 | 3.7 | 3.1 |
| | Fe₂O₃ | 0.3 | 2.8 | 5.0 | 2.4 |
| | CaO | 67.1 | 63.6 | 64.1 | 66.9 |
| | Free lime | 2.1 | 0.6 | 1.5 | 0.8 |
| | CaO | 65.0 | 63.0 | 62.6 | 66.1 |
| | combined | | | | |
| Bogue | C3S = | 71.6 | 63.6 | 65.5 | 74.5 |
| calculation | C2S = | 12.4 | 9.2 | 10.1 | 8.1 |
| | C3A = | 6.1 | 10.1 | 1.3 | 4.2 |
| | C4AF = | 0.8 | 8.5 | 15.2 | 7.3 |

Additives:
Salt of Iron (III): Ferric sulfate is used in its monohydrate form: Fe₂(SO₄)₃.H₂O.
Salt of iron (II): Ferrous sulfate is used in its heptahydrate form: FeSO₄.7H₂O.
Alkanolamine: Triisopropanolamine (TIPA) is used.
Antifoaming agent (AF): FoamStar® PB 2922 commercialized by BASF is used.
Source of calcium oxide: CaO commercialized by VWR.

Production Process of Mortars in the Following Examples

The production process of mortars is consistent with NF EN 196-1 standard:
Mixing
Preparing the test specimen by casting in a steel mould a first layer followed by compacting with a vibrating table and casting a second layer followed by compacting with a vibrating table.
Demoulding after 24 hours
Storage in a humidity chamber 100% HR.

Composition of the Mortar:
450 g of binder
225 g of water
1350 g of standard sand
Optionally additives indicated in the tables in the examples.

Additives are mainly used as powders and are added with the cement unless indicated otherwise.

If additives are used as diluted solutions or hydrated powders, the amount of mixing water is adjusted so as to have a W/C ratio constant between the examples.

Compressive strength at 24 hours, 7 days and 28 days are tested at 2000 unless indicated otherwise.

Comparison Between Sulfate Salt of Iron(II) and Salt of Iron(III) as Additives:

The following tests have been run with ferric sulfate and ferrous sulfate.

TABLE 2

| | | | | | | | Compressive | | |
|---|---|---|---|---|---|---|---|---|---|
| | | weight | amount % | amount % | | | strength (MPa) | | |
| no | Fe(II)/Fe(III) | (g) | Fe/cement | SO4/cement | % AF | % CaO | 1 d | 7 d | 28 d |

CEM I 52.5 Le Teil Blanc

| | | | | | | | | | |
|---|---|---|---|---|---|---|---|---|---|
| 1a | — | — | — | — | — | — | 24 | 44 | 58 |
| 2a | Fe(II) SO₄ | 7 | 0.31 | 0.54 | 0.05 | — | 24 | 46 | 61 |
| 3a | Fe(II) SO₄ | 14 | 0.63 | 1.07 | 0.05 | — | 23 | 45 | 59 |
| 4a | Fe₂(III) (SO₄)₃ | 7 | 0.42 | 1.07 | 0.05 | — | 30 | 49 | 62 |

CEM I 52.5 Singapore

| | | | | | | | | | |
|---|---|---|---|---|---|---|---|---|---|
| 1b | — | — | — | — | — | — | 14 | 45 | 59 |
| 2b | Fe(II) SO₄ | 7 | 0.31 | 0.54 | 0.05 | 0.9 | 13 | 50 | 65 |
| 3b | Fe(II) SO₄ | 14 | 0.63 | 1.07 | 0.05 | 0.9 | 12 | 47 | 61 |
| 4b | Fe₂(III) (SO₄)₃ | 7 | 0.42 | 1.07 | 0.05 | 0.9 | 18 | 51 | 65 |

CEM I 52.5 Val d'Azergue PMES

| | | | | | | | | | |
|---|---|---|---|---|---|---|---|---|---|
| 1c | — | — | — | — | — | — | 18 | 44 | 57 |
| 2c | Fe(II) SO₄ | 7 | 0.31 | 0.54 | 0.05 | — | 17 | 47 | 62 |
| 3c | Fe(II) SO₄ | 14 | 0.63 | 1.07 | 0.05 | — | 15 | 46 | 62 |
| 4c | Fe₂(III) (SO₄)₃ | 7 | 0.42 | 1.07 | 0.05 | — | 20 | 49 | 62 |

CEM I 52,5 Le Teil Gris PMES

| | | | | | | | | | |
|---|---|---|---|---|---|---|---|---|---|
| 1d | — | — | — | — | — | — | 21 | 51 | 67 |
| 2d | Fe(II) SO₄ | 7 | 0.31 | 0.54 | 0.05 | 0.9 | 15 | 48 | 66 |
| 3d | Fe(II) SO₄ | 14 | 0.63 | 1.07 | 0.05 | 0.9 | 11 | 47 | 66 |
| 4d | Fe₂(III) (SO₄)₃ | 7 | 0.42 | 1.07 | 0.05 | 0.9 | 25 | 55 | 72 |

Ferric sulfate lead to an increase of the compressive strength at 1 day, 7 days and 28 days for all the cements tested.

Ferrous sulfate lead mainly to a slight increase of compressive strength at 7 days and 28 days, but the compressive strength at 1 day is impaired with such an additive.

Influence of the Sulfate Ion

TABLE 3

| | | | | | | | Compressive | | |
|---|---|---|---|---|---|---|---|---|---|
| | | weight | amount % | amount % | | | strength (MPa) | | |
| no | Na/Al/Fe | (g) | Fe/cement | SO4/cement | % AF | % CaO | 1 d | 7 d | 28 d |

CEM I 52.5 Le Teil Blanc

| | | | | | | | | | |
|---|---|---|---|---|---|---|---|---|---|
| 1e | — | — | — | — | — | — | 24 | 44 | 58 |
| 2e | Na₂SO₄ | 7.1 | — | 1.07 | 0.05 | | 25 | 44 | 56 |
| 3e | Al₂(SO₄)₃ | 5.72 | — | 1.07 | 0.05 | | 24 | 44 | 54 |
| 4e | Fe₂(III) (SO₄)₃ | 7 | 0.42 | 1.07 | 0.05 | — | 30 | 49 | 62 |

There is barely any effect on the compressive strength when aluminium sulfate or sodium sulfate is used as additive.

This confirms that the effect of ferric sulfate on the compressive strength comes from the iron and not the sulfate.

Iron(III) Chloride

TABLE 4

| | | | | | | | Compressive | | |
|---|---|---|---|---|---|---|---|---|---|
| | | weight | amount % | amount % | | | strength (MPa) | | |
| no | Fe | (g) | Fe/cement | Cl/cement | % AF | % CaO | 1 d | 7 d | 28 d |

CEM I 52.5 Le Teil Blanc

| | | | | | | | | | |
|---|---|---|---|---|---|---|---|---|---|
| 1f | — | — | — | — | — | — | 24 | 44 | 58 |
| 2f | Fe(II)Cl₂ | 2.1 | 0.21 | 0.26 | — | — | 29 | 51 | 61 |
| 3f | Fe(III)Cl₃ | 1.8 | 0.14 | 0.26 | — | — | 33 | 53 | 64 |

It is supposed that iron chloride can be transformed in the presence of cement into calcium chloride, which is known as a set accelerator.

To this extent, both Iron(II) chloride and Iron(III) chloride improve compressive strength. However, it can be noticed that Iron(III) chloride gives even better results.

Comparison Between an Acidic Salt and an Alkaline Salt of Iron (III)

7 g of Fe₂(SO₄)₃.H₂O are precipitated with soda (20%) in 50 mL of water. Soda is added until pH 11. A red precipitate is obtained, washed three times with water and filtered. The filtered solid obtained (3.6 g) is added in the cement before addition of water.

TABLE 5

| | | | | | | | Compressive | | |
|---|---|---|---|---|---|---|---|---|---|
| | | weight | amount % | amount % | | | strength (MPa) | | |
| no | Fe | (g) | Fe/cement | SO4/cement | % AF | % CaO | 1 d | 7 d | 28 d |

CEM I 52.5 Le Teil Blanc

| | | | | | | | | | |
|---|---|---|---|---|---|---|---|---|---|
| 1h | — | — | — | — | — | — | 24 | 44 | 58 |
| 2h | Fe(OH)₃ | 3.6 | 0.42 | — | — | — | 23 | 40 | 52 |
| 3h | Fe₂(III) (SO₄)₃ | 7 | 0.42 | 1.07 | 0.05 | — | 30 | 49 | 62 |

The use of alkaline salt of Iron (III) is detrimental to the compressive strength.

Synergy of Iron(III) Salt with an Alkanolamine

TABLE 6

| | | | | | | | Compressive | | |
|---|---|---|---|---|---|---|---|---|---|
| | | weight | amount % | amount % | | | strength (MPa) | | |
| no | Fe(II)/Fe(III) | (g) | Fe/cement | SO4/cement | % AF | % TIPA | 1 d | 7 d | 28 d |

CEM I 52.5 LeTeil Blanc

| | | | | | | | | | |
|---|---|---|---|---|---|---|---|---|---|
| 1i | — | — | — | — | — | — | 24 | 44 | 58 |
| 2i | — | — | — | — | — | 0.2 | 24 | 47 | 59 |
| 3i | Fe₂(III) (SO₄)₃ | 7 | 0.42 | 1.07 | — | 0.2 | 28 | 50 | 61 |
| 4i | — | — | — | — | 0.05 | 0.2 | 24 | 46 | 59 |
| 5i | Fe(II) SO₄ | 14 | 0.63 | 1.07 | 0.05 | — | 23 | 45 | 59 |
| 6i | Fe(II) SO₄ | 14 | 0.63 | 1.07 | 0.05 | 0.2 | 22 | 46 | 60 |
| 7i | Fe₂(III) (SO₄)₃ | 7 | 0.42 | 1.07 | 0.05 | — | 30 | 49 | 62 |
| 8i | Fe₂(III) (SO₄)₃ | 7 | 0.42 | 1.07 | 0.05 | 0.2 | 29 | 50 | 60 |

CEM I 52.5 Val d'Azergue PMES

| | | | | | | | | | |
|---|---|---|---|---|---|---|---|---|---|
| 1j | — | — | — | — | — | — | 18 | 44 | 57 |
| 2j | — | — | — | — | — | 0.1 | 20 | 49 | 71 |
| 3j | Fe(II) SO₄ | 7 | 0.31 | 0.54 | 0.05 | — | 17 | 47 | 62 |
| 4j | Fe(II) SO₄ | 7 | 0.31 | 0.54 | 0.05 | 0.1 | 11 | 48 | 71 |
| 5j | Fe(II) SO₄ | 14 | 0.63 | 1.07 | 0.05 | — | 15 | 46 | 62 |
| 6j | Fe(II) SO₄ | 14 | 0.63 | 1.07 | 0.05 | 0.1 | 9 | 41 | 70 |
| 7j | Fe₂(III) (SO₄)₃ | 7 | 0.42 | 1.07 | 0.05 | — | 20 | 49 | 62 |
| 8j | Fe₂(III) (SO₄)₃ | 7 | 0.42 | 1.07 | 0.05 | 0.1 | 22 | 55 | 74 |

Synergy of Iron(III) Salt with an Alkanolamine, a Source of Calcium Oxide and an Antifoaming Agent

TABLE 7

| | | | | | | | | Compressive | | |
|---|---|---|---|---|---|---|---|---|---|---|
| | | weight | amount % | amount % | | | | strength (MPa) | | |
| no | Fe(II)/Fe(III) | (g) | Fe/cement | SO4/cement | % AF | % TIPA | % CaO | 1 d | 7 d | 28 d |

CEM I 52.5 Le Teil Blanc

| | | | | | | | | | | |
|---|---|---|---|---|---|---|---|---|---|---|
| 1l | — | — | — | — | — | — | — | 24 | 44 | 58 |
| 2l | — | — | — | — | 0.05 | 0.2 | — | 24 | 46 | 59 |
| 3l | Fe₂(III) (SO₄)₃ | 7 | 0.42 | 1.07 | 0.05 | — | — | 30 | 49 | 62 |
| 4l | Fe₂(III) (SO₄)₃ | 7 | 0.42 | 1.07 | 0.05 | 0.2 | — | 29 | 50 | 60 |
| 5l | Fe₂(III) (SO₄)₃ | 7 | 0.42 | 1.07 | 0.05 | 0.2 | 0.9 | 29 | 50 | 60 |

CEM I 52.5 Singapore

| | | | | | | | | | | |
|---|---|---|---|---|---|---|---|---|---|---|
| 1m | — | — | — | — | — | — | — | 14 | 45 | 59 |
| 2m | — | — | — | — | 0.05 | 0.1 | 0.9 | 15 | 49 | 66 |
| 3m | Fe₂(III) (SO₄)₃ | 7 | 0.42 | 1.07 | 0.05 | — | 0.9 | 18 | 51 | 65 |
| 4m | Fe₂(III) (SO₄)₃ | 7 | 0.42 | 1.07 | 0.05 | 0.1 | 0.9 | 19 | 58 | 72 |

CEM I 52.5 Val d'Azergue PMES

| | | | | | | | | | | |
|---|---|---|---|---|---|---|---|---|---|---|
| 1n | — | — | — | — | — | — | — | 18 | 44 | 57 |
| 2n | — | — | — | — | — | 0.1 | — | 20 | 49 | 71 |
| 3n | Fe₂(III) (SO₄)₃ | 7 | 0.42 | 1.07 | 0.05 | — | — | 20 | 49 | 62 |
| 4n | Fe₂(III) (SO₄)₃ | 7 | 0.42 | 1.07 | 0.05 | — | 0.9 | 21 | 50 | 62 |
| 5n | Fe₂(III) (SO₄)₃ | 7 | 0.42 | 1.07 | 0.05 | 0.1 | — | 22 | 55 | 74 |
| 6n | Fe₂(III) (SO₄)₃ | 7 | 0.42 | 1.07 | 0.05 | 0.1 | 0.9 | 25 | 54 | 74 |

CEM I 52.5 Le Teil Gris PMES

| | | | | | | | | | | |
|---|---|---|---|---|---|---|---|---|---|---|
| 1o | — | — | — | — | — | — | — | 21 | 51 | 67 |
| 2o | — | — | — | — | — | 0.1 | — | 19 | 52 | 78 |
| 3o | Fe₂(III) (SO₄)₃ | 7 | 0.42 | 1.07 | 0.05 | — | 0.9 | 25 | 55 | 72 |
| 4o | Fe₂(III) (SO₄)₃ | 7 | 0.42 | 1.07 | 0.05 | 0.1 | 0.9 | 26 | 65 | 84 |

Amount of Salt of Iron(III)

TABLE 8

| | | | | | | Compressive | | |
|---|---|---|---|---|---|---|---|---|
| | | weight | amount % | amount % | | strength (MPa) | | |
| no | Fe(II)/Fe(III) | (g) | Fe/cement | SO4/cement | % AF | 1 d | 7 d | 28 d |

CEM I 52.5 Le Teil Blanc

| | | | | | | | | |
|---|---|---|---|---|---|---|---|---|
| 1p | — | — | — | — | — | 24 | 44 | 58 |
| 2p | Fe₂(III) (SO₄)₃ | 15 | 0.89 | 2.3 | 0.05 | 31 | 52 | 61 |
| 3p | Fe₂(III) (SO₄)₃ | 7 | 0.42 | 1.07 | 0.05 | 30 | 49 | 62 |
| 4p | Fe₂(III) (SO₄)₃ | 3.5 | 0.21 | 0.54 | 0.05 | 29 | 46 | 61 |
| 5p | Fe₂(III) (SO₄)₃ | 1.75 | 0.1 | 0.27 | 0.05 | 27 | 46 | 62 |

Influence of the Temperature

TABLE 9

| | | | | | | Compressive | | |
|---|---|---|---|---|---|---|---|---|
| | | weight | amount % | amount % | | strength (MPa) | | |
| no | Fe(II)/Fe(III) | (g) | Fe/cement | SO4/cement | % AF | 1 d | 7 d | 28 d |

CEM I 52.5 Le Teil Blanc
At 30° C.

| | | | | | | | | |
|---|---|---|---|---|---|---|---|---|
| 1q | — | — | — | — | — | 26 | 42 | 53 |
| 2q | Fe₂(III) (SO₄)₃ | 7 | 0.42 | 1.07 | 0.05 | 32 | 48 | 56 |

At 5° C.

| | | | | | | | | |
|---|---|---|---|---|---|---|---|---|
| 1r | — | — | — | — | — | 6 | 40 | 55 |
| 2r | Fe₂(III) (SO₄)₃ | 7 | 0.42 | 1.07 | 0.05 | 8 | 46 | 61 |

1. A method comprising adding an acidic salt of Iron (III) as additive to cement, mortar or concrete.

2. The method according to claim 1, wherein the acidic salt of Iron (III) is selected from the group comprising iron(III) sulfate, iron (III) chloride, iron (III) nitrate, iron (III) carboxylate and combinations thereof.

3. The method according to claim 1, wherein alkanolamine is used in combination with the acidic salt of Iron(III).

4. Composition of additives for cement, mortar or concrete, comprising an acidic salt of Iron (III) and an alkanolamine.

5. The composition of additives according to claim 4, wherein the alkanolamine is selected from the group comprising N,N bis-(2-hydroxyethyl)-2-propanolamine) (DIEPA), N, N bis-(2-hydroxypropyl)-N-(hydroxyethyl) amine (EDIPA), diethanolamine (DEA), triethanolamine (TEA), triisopropanolamine (TIPA), hydroxyethyldiethylenetriamine (HEDETA), and aminoethylethanolamine (AEEA) and combinations thereof.

6. The composition of additives according to claim 4, further comprising a source of calcium oxide.

7. The composition of additives according to claim 4, further comprising an antifoaming agent.

8. Method for improving compressive strength of hydraulic cement composition comprising a Portland cement, wherein an acidic salt of Iron (III) is added to the hydraulic cement composition.

9. The method according to claim 8, wherein the salt of Iron (III) is selected from the group comprising iron(III) sulfate, iron (III) chloride, iron (III) nitrate, iron (III) carboxylate and combinations thereof.

10. The method according to claim 8, wherein an alkanolamine is further added to the hydraulic cement composition.

11. The method according to claim 10, wherein the alkanolamine is selected from the group comprising N,N bis-(2-hydroxyethyl)-2-propanolamine) (DIEPA), N, N bis-(2-hydroxypropyl)-N-(hydroxyethyl) amine (EDIPA), diethanolamine (DEA), triethanolamine (TEA), triisopropanolamine (TIPA), hydroxyethyldiethylenetriamine (HEDETA), and aminoethylethanolamine (AEEA) and combinations thereof.

12. The method according to claim 8, wherein a source of calcium oxide is further added to the hydraulic cement composition.

13. The method according to claim 8, wherein an antifoaming agent is further added to the hydraulic cement composition.

14. The method according to claim 8, wherein at least 0.1% by weight, compared to the total weight of binder, of salt of Iron (III) is added.

15. The method according to claim 8, wherein at least 0.02% by weight, compared to the total weight of binder, of alkanolamine is added.

16. Cement hydraulic binder comprising Portland cement and at least one acidic salt of Iron (III).

17. The cement hydraulic binder according to claim 16, comprising at least 0.1% by weight of Iron (Fe) compared to the total weight of binder.

18. The cement hydraulic binder according to claim 16, further comprising an alkanolamine.

19. The cement hydraulic binder according to claim 16, comprising at least 0.8% by weight, compared to the total weight of binder, of free calcium oxide.

20. The cement hydraulic binder according to claim 16, further comprising an antifoaming agent.

21. Hydraulic cement composition comprising the cement hydraulic binder as defined in claim 16.

22. A structure formed from the hydraulic cement composition as defined in claim 21.
